(19) United States
(12) Patent Application Publication
(10) Pub. No.: US 2012/0180226 A1
(43) Pub. Date: Jul. 19, 2012

(54) Elongated scraper-hammer

(76) Inventor: Jorgen Pedersen, Nanton (CA)

(21) Appl. No.: 12/929,319

(22) Filed: Jan. 14, 2011

(51) Int. Cl. B25F 1/00; B25D 1/04

(52) U.S. Cl. 7/144

(57) ABSTRACT

A scraper-hammer is provided that has a handle and a head connected to the handle. The head has a first surface and a second surface. The head has a longitudinal extending scraping edge that is sharp and which is defined by the intersection of surfaces and along the head's upper periphery. The head has a striking surface for striking fasteners that faces outwardly in the same general direction of the longitudinal axis of the scraping edge.

### FIELD

The present invention relates to tools. More specifically, the present invention relates to surface scrapers having an elongated handle.

### BACKGROUND

Scrapers are commonly used in the flooring industry to scrape paint, glue, cement, grout, etc. from different work surfaces.

Scrapers can take a variety of shapes depending on the type of surface, the type of material that is to be removed, and the size of the surface. Furthermore, scrapers have a variety of features that can improve functionality and ease of operation. Such features include scraper blades that can be easily detached by unfastening screws for easy sharpening or replacement, and the addition of one or more tool features, such as a striking surface, hammer head, mallet, pick, or ball-pein.

A hammer head is particularly useful for driving in nails or other protrusions that might interfere with the installation of new flooring. However, the addition of a hammer head that is perpendicular to the top flat surface of a scraper blade significantly increases the height of the scraper and makes it difficult to scrape material from a surface that is underneath fixed furniture or stairs.

Furthermore, the addition of a hammer head that is perpendicular to the top flat surface of a scraper blade imposes restrictions on the width and length of the blade when trying to hammer in nails. The wider and longer the blade is, the more difficult it is to strike a nail squarely on the head because it is hidden by the blade.

Therefore, there is a need for a scraper that includes a hammer head which does not increase the scraper's overall height. There is a further need for a scraper that includes a hammer head which can accommodate wide scraping blades without impairing accuracy when striking nails or other fasteners.

### BRIEF SUMMARY

The present invention provides a scraper-hammer that has the lowest possible height and can accommodate wide blades without impairing the ability to strike nails squarely on the head.

The present invention provides a scraper-hammer having a head, the head having a first side and a second side and a scraping edge for scraping and a first striking surface for striking, the first side and the second side forming a longitudinal axis, the scraping edge extending in the direction of the longitudinal axis, the first striking surface facing outwardly in the general direction of the scraping edge and a handle, the handle extending from the head.

### BRIEF DESCRIPTION OF THE FIGURES

Preferred embodiments of the present invention will now be described in greater detail and will be better understood when read in conjunction with the following drawings in which:

FIG. 1A is a right side view of a scraper-hammer in accordance with one embodiment of the present invention;

FIG. 1B is an front elevation view of the scraper-hammer illustrated in FIG. 1,

FIG. 2 is a right side view of a scraper-hammer in accordance with another embodiment of the present invention;

FIG. 3 is a left side view of the scraper-hammer illustrated in FIG. 2;

FIG. 4 is an exploded right side view of the scraper-hammer illustrated in FIG. 2;

FIG. 5 is a perspective view of the head of the scraper-hammer illustrated in FIG. 2;

FIG. 6A is a bottom view of the plate of the scraper-hammer illustrated in FIG. 2; and

FIG. 6B is a top view of the plate of the scraper-hammer illustrated in FIG. 2.

### DETAILED DESCRIPTION

The present invention provides a scraper-hammer that has the lowest possible height and can accommodate wide blades without impairing the ability to squarely strike nails on the head.

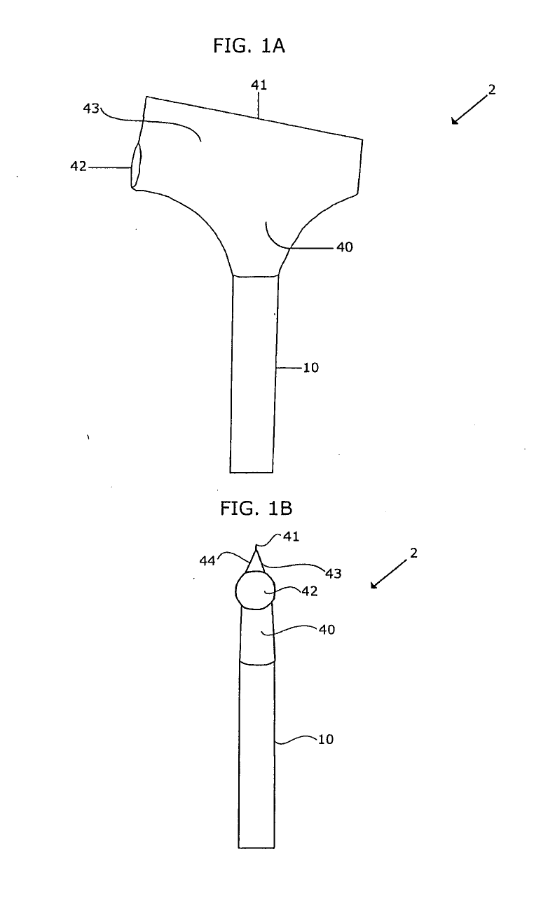

A scraper-hammer in accordance with at least one embodiment of the invention is illustrated in FIGS. 1A and 1B. As shown, scraper-hammer 2 has a handle 10 and a head 40 connected to handle 10. Head 40 and handle 10 can be formed as single piece or multiple pieces suitably connected together. Head 40 has a first surface 43 and an analogous second surface 44 on the opposite side of head 40 as seen in FIG. 1B. Head 40 has a longitudinal extending scraping edge 41 that is sharp and which is defined by the intersection of surfaces 43 and 44 along the head's upper periphery. Head 40 additionally includes a striking surface 42 that faces outwardly. The plane of the striking surface 42 will typically be orthogonal to the longitudinal axis of edge 41 but it can also be at a selected angle relative thereto depending upon the preferred angle of attack for striking nails or other objects.

In the embodiment of FIGS. 1A and 1B, head 40, including first and second surfaces 43, 44, edge 41, and striking surface 42 are formed as an integral unitary component created by stamping, milling, forging, or casting in order to provide maximum durability and strength. This embodiment provides a scraper-hammer that is particularly durable and well suited to the demands of a construction jobsite. As will be appreciated however, scraping edge 41 is not replaceable, requiring instead that it be periodically sharpened from time to time.

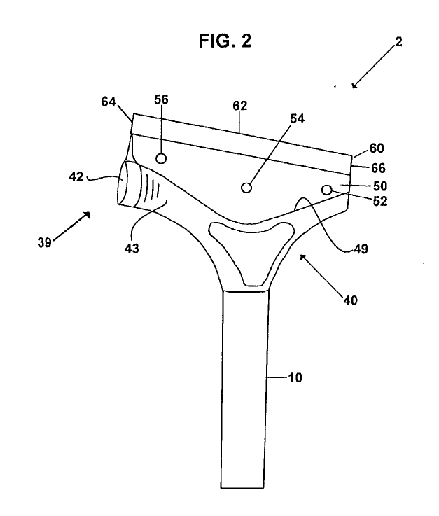

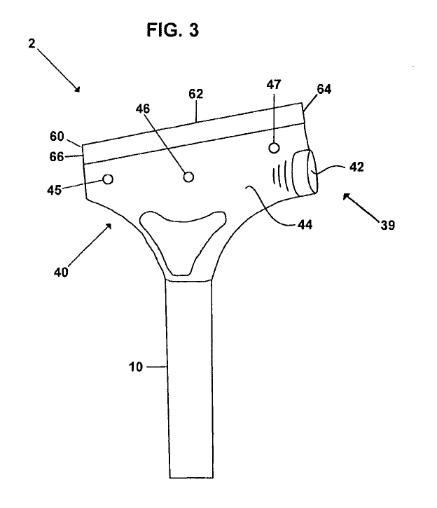

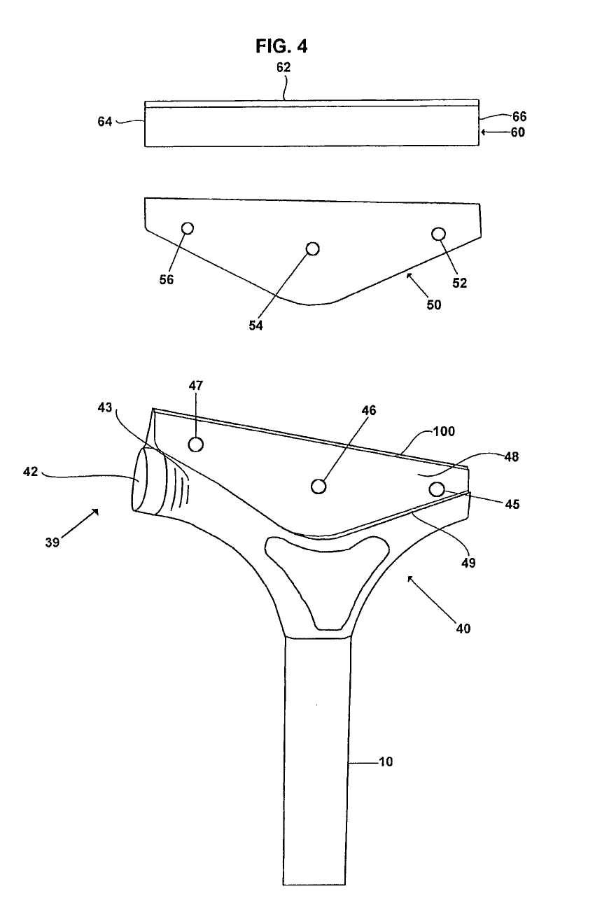

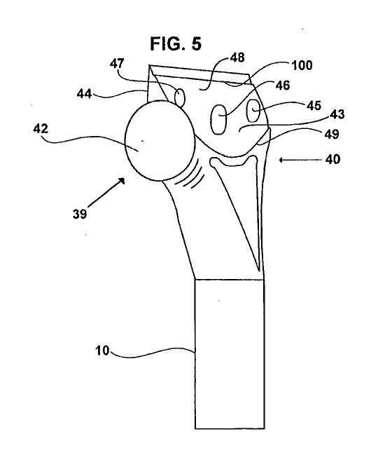

A scraper-hammer in accordance with another embodiment of the invention is illustrated in FIGS. 2, 3, 4 and 5 wherein like numerals have been used to identify like elements. As shown, scraper-hammer 2 has a handle 10 and a head 40 connected to handle 10. With reference to FIGS. 2 and 3, head 40 has a first surface 43 and a second surface 44 and a hammer head 39 with a striking surface 42 for striking. As seen in FIGS. 4 and 5, first surface 43 can further include or have formed into it a generally flat recessed surface 48 bounded along its lower edge by a shoulder 49. Recessed surface 48 can also include a recessed groove 100 which is adapted to receive a blade 60, which will be discussed in greater detail below. Head 40 also has at least one hole and more preferably three spaced apart holes 45, 46, 47 that extend laterally through head 40 from first surface 43 to second surface 44 for receiving a fastener. In at least one embodiment, holes 45, 46, 47 are not threaded.

As seen in FIG. 4, blade 60 has a first end 64 and a second end 66 and a longitudinally extending scraping edge 62 that extends between ends 64 and 66 along the upper periphery of blade 60. A plate 50 is used to connect blade 60 to head 40 as will now be described in more detail.

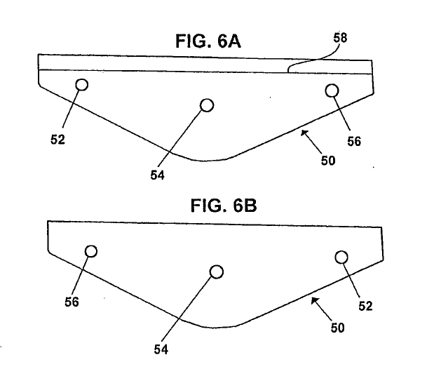

With reference to FIGS. 6A and 6B, at least one embodiment of plate 50 is illustrated. Plate 50 can take a shape that is generally similar to recessed surface 48 such that the lower curved portion of plate 50 abuts against shoulder 49 when the scraper-hammer is assembled, as seen in FIG. 2. Plate 50 contains at least one but more preferably three spaced apart holes 52, 54, 56 which are adapted to receive a fastener. In at least one embodiment, holes 52, 54, 56 are threaded to receive a machine screw that is inserted from second surface 44 of head 40 through holes 45,46,47 and threaded into holes 52, 54, 56. As will be understood by the skilled person, when the machine screws are tightened, plate 50 is forcibly biased against head 40.

As seen in FIG. 6A, the underside of plate 50 can also have a recessed groove 58 which will be disposed longitudinally adjacent to groove 100 when plate 50 is fastened to head 40 in the manner described above. In this way and as will be understood by the skilled person, blade 60 fits within the resultant channel formed between surface 48 groove 58 and groove 100 when plate 50 is fixed to head 40. This resultant channel is sized such that it is slightly narrower than the thickness of blade 60, such that blade 60 is forcibly gripped under compression in the channel when plate 50 is fixed to head 40.

Turning back to FIGS. 2, 3, 4 and 5, hammer head 39 is oriented outwardly in the same general direction as the longitudinal axis of blade edge 62 but again, this is subject to the selection of another angle that might be more preferred. As will be understood, a user can replace blade 60 when required by loosening the fasteners fixing plate 50 to head 40 and replacing the old blade with a new one.

As discussed above, plate 50 can be affixed to head 40 by any suitable fastener, including but not limited to a rivet, nail, bolt or machine screw among other fasteners that will be readily apparent to the skilled person.

In an alternative embodiment of the present invention, head 40 can have a second striking surface (not shown) for striking. The second striking surface can face outwardly in the same general direction of the longitudinal axis of scraping edge 62 and in the general opposite direction from first striking surface 42. Or the two striking surfaces can be oriented at respectively different angles relative to the blade's longitudinal axis to provide a choice of orientations.

In alternative embodiments of the present invention, hammer head 39 can instead be a mallet, or a rubber head hammer, a pick, a ball-pein hammer or a straight pein hammer, among other types of striking tools. In a similar way, the second striking surface, if any, can be a hammer, a mallet, a rubber head hammer, a pick, a ball pein hammer or a straight pein hammer, among other types of striking surfaces.

In another embodiment of the present invention scraper-hammer 2 has a set of hammer claws (not shown) attached to head 40 such that a nail or other fastening devices can be removed without using a second tool as will be readily understandable by a person skilled in the art.

Head 40, handle 10, plate 50 and blade 60 can be formed out of carbon steel, tool steel, hardened steel, stainless steel, alloyed steel, aluminum, cast iron, rigid plastic and strain-hardened plastic among other materials. Head 40, handle 10, plate 50 and blade 60 can be formed by any suitable manufacturing process such as stamping, milling, forging, and casting among other manufacturing techniques provided that head 40, handle 10, plate 50 and blade 60 are sufficiently strong and durable.

Hammer head 39, striking surface 42 and a possible second striking surface can form an integral part of head 40 or can form a distinct parts that are suitably connected to head 40, for example, by welding the striking portions to head 40.

In another embodiment, handle 10 can include a threaded end (not shown) to screw handle 10 into a threaded screw socket in head 40. Handle 10 can include a grip made out of rope, rubber, tape, and plastic among other materials.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following claims.

1. A scraper-hammer comprising:
a head said head having a first surface and a second surface and a scraping edge for scraping and a first striking surface for striking, said first surface and said second surface forming a longitudinal axis, said scraping edge extending in the direction of said longitudinal axis, said first striking surface facing outwardly in the general direction of said scraping edge; and
a handle, said handle extending from said head.

2. The scraper-hammer of claim 1 wherein said scraping edge is integrally formed in said head.

3. The scraper-hammer of claim 1 wherein said head further comprised a blade, said blade having a first side and a second side, said scraping edge extending between said first side of said blade and said second side of said blade.

4. The scraper-hammer of claim 3 wherein said head further comprises at least one head hole for receiving a fastener and said blade further comprises at least one blade hole for receiving a fastener, said at least one blade hole aligned with said at least one head hole.

5. The scrape-hammer of claim 4 wherein said head further comprises a plate for forcibly fixing said blade to said head, said plate being attached to said head.

6. The scraper-hammer of claim 5 wherein said plate further comprises at least one plate hole aligned with said at least one head hole for receiving a fastener.

7. The scraper-hammer of claim 1 wherein said first striking surface further comprises one of a hammer, mallet, a pick, a ball pein, and a straight pein.

8. The scraper-hammer of claim 1 wherein said head further comprises a second striking surface for striking, said second striking surface facing outwardly in the general direction of the longitudinal axis of said scraping edge and in the opposite general direction from said first striking surface.

9. The scraper-hammer of claim 8 wherein said second striking surface comprises one of a mallet, a pick, a ball pein, and a straight pein.

10. The scraper-hammer of claim 1 further comprising a pair of hammer claws for removing fasteners attached to one of said head, said pair of hammer claws facing outwardly in the direction of the longitudinal axis of said blade edge and in the opposite general direction from said first striking surface.

11. The scraper-hammer of claim 1 wherein said first striking surface is an integral part of said head.

12. The scraper-hammer of claim 8 wherein said second striking surface is an integral part of said head.

13. The scraper-hammer of claim 1 wherein said handle is integrally formed with said head.
